(19) United States
(12) Patent Application Publication
(10) Pub. No.: US 2025/0340153 A1
(43) Pub. Date: Nov. 6, 2025

(54) DRIVE DEVICE FOR APPLYING AN OPPOSING FORCE FOR PREVENTING AN UNDESIRED ADJUSTMENT OF AN INTERIOR ASSEMBLY

(71) Applicant: BROSE FAHRZEUGTEILE SE & CO. KOMMANDITGESELLSCHAFT, COBURG, Coburg (DE)

(72) Inventors: Florian POHL, Ebersdorf (DE); Alex KROMER, Stegaurach (DE); Alexander MÜLLER, Bischberg (DE); Alexander CZEMPIK, Markkleeberg (DE)

(21) Appl. No.: 18/870,290

(22) PCT Filed: May 26, 2023
(86) PCT No.: PCT/EP2023/064149

§ 371 Date: Jan. 7, 2025

(30) Foreign Application Priority Data
Jun. 2, 2022 (DE) 10 2022 114 000.8

(51) Int. Cl. B60N 2/02

(52) U.S. Cl. CPC B60N 2/02246; B60N 2/0272; B60N 2205/20

(57) ABSTRACT

It is provided a drive device for adjusting an interior assembly of a vehicle, having, at least comprising, a motor-type adjusting drive for generating an adjusting force, a kinematic adjusting mechanism to be driven by the adjusting drive for transmitting an adjusting force generated by the adjusting drive to the interior assembly, a control device for controlling the adjusting drive, and an electronic detection device for detecting an adjustment event, in which at least one external force acts on the drive device and/or the interior assembly. The control device is configured to generate an opposing force via the motor-type adjusting drive in response to the detection of the adjustment event, which counteracts an adjustment of the interior assembly due to the external force.

### CROSS REFERENCE TO RELATED APPLICATIONS

The present application is a U.S. National Phase of International Application No. PCT/EP2023/064149 entitled “DRIVE DEVICE FOR APPLYING AN OPPOSING FORCE FOR PREVENTING AN UNDESIRED ADJUSTMENT OF AN INTERIOR ASSEMBLY,” and filed on May 26, 2023. International Application No. PCT/EP2023/064149 claims priority to German Patent Application No. 10 2022 114 000.8 filed on Jun. 2, 2022. The entire contents of each of the above-listed applications are hereby incorporated by reference for all purposes.

### BACKGROUND

This solution relates to a drive device for adjusting an interior assembly of a vehicle.

Such a drive device comprises a motor-type adjusting drive for generating an adjusting force, a kinematic adjusting mechanism, which can be driven by the adjusting drive, for transmitting an adjusting force generated by the adjusting drive to the interior assembly, and a control device for controlling the adjusting drive. In addition, there is provided an electronic detection device via which an adjustment event can be detected, in which at least one external force acts on the drive device and/or the interior assembly.

It is already widely known to adjust different types of interior assemblies in a power-operated way via a motor-type adjusting drive. An interior assembly of the type described here is an assembly in the interior of a vehicle. An interior assembly of the type described here for example can be a vehicle seat, a console element with a storage or deposition function, a monitor, a dividing wall or a shelf such as a table or a storage compartment. The interior assembly does not form part of the vehicle body and in so far does not serve for closing the vehicle towards the outside (as this is the case in a vehicle door or a sliding roof). The interior assembly neither forms part of a drive and steering system of the vehicle (such as a steering column of a vehicle). The interior assembly is arranged in the interior of the vehicle and can be adjusted by a user in the interior, in particular in order to provide a comfort function in the interior.

For example, a vehicle seat can be adjustable for setting a backrest inclination, a longitudinal and/or transverse position, or also for setting a rotational position in the interior, in order to provide a comfortable seating position for a vehicle occupant. A console element for example can be shiftable along a vehicle floor, in order to provide a shelf in the interior of the vehicle or to enable actuation of a functional assembly on the console element. A monitor can be adjustable in its swivel position, its height position and/or its tilt position, in order to enable comfortable viewing of the monitor for a vehicle occupant.

In particular in novel interior concepts, for example in connection with autonomously driving vehicles, interior assemblies such as vehicle seats or console elements can be variably adjustable in order to possibly enable vehicle occupants to ride comfortably in the vehicle. It here should be possible to perform the adjustment of an interior assembly by a user in a simple, comfortable and intuitive way.

The adjusting drive and/or the kinematic adjusting mechanism frequently are designed here to be self-locking, so that the kinematic adjusting mechanism and hence the interior assembly can be adjusted only by actuating the adjusting drive, but conversely an adjustment cannot be effected by an external force. In a vehicle seat, for example, self-locking of a transmission together with a latching moment of an adjusting motor and possible poor efficiencies along the functional chain can be responsible for the fact that the vehicle seat is not lowered unintentionally in the case of a vibration of the vehicle, for example when driving on a rough road. A design of the adjusting drive and/or the kinematic adjusting mechanism with a self-locking feature, however, is not absolutely desirable due to poor efficiencies. Typically, this also involves a need of more installation space and an increase in weight and wear.

Against this background it is the object underlying the proposed solution to provide a drive device which is improved in this respect.

A proposed drive device for adjusting an interior assembly of a vehicle at least includes
a motor-type adjusting drive for generating an adjusting force,
a kinematic adjusting mechanism, which can be driven by the adjusting drive, for transmitting an adjusting force generated by the adjusting drive to the interior assembly,
an electronic control device for controlling the adjusting drive, and
an electronic detection device for detecting an adjustment event, in which at least one external force acts on the drive device and/or the interior assembly.

The control device here is configured to generate an opposing force via the motor-type adjusting drive in response to the detection of the adjustment event, which counteracts an adjustment of the interior assembly due to the external force.

The proposed solution hence proceeds from the fundamental idea to apply an opposing force in an electronically controlled way, with which on detection of an adjustment event an external force is counteracted to such an extent that no undesired adjustment of the interior assembly occurs. A proposed drive device thus is capable of not only controlling a targeted adjustment of an interior assembly of a vehicle via the motor-type adjusting drive, but also of counteracting an undesired adjustment by means of the adjusting drive in the presence of an adjustment event. This for example provides for a drive device with a controller-based adjuster (i.e. a control device integrated in a controller in combination with a motor-type adjusting drive, including a motor-integrated electronic unit), which with an adjusting drive without a self-locking feature and a kinematic adjusting mechanism without a self-locking feature counteracts an undesired adjustment of an interior assembly due to applied external forces by specifically applying an opposing force. In particular, the proposed solution here can also achieve a contribution to an increase in reach of electric vehicles. Due to the increase in efficiency by using an adjusting drive without a self-locking feature, a travel current to be applied for the regular operation of the drive device can be lower. An energy accumulator of the vehicle provided for the drive of the vehicle and the operation of the drive device thus possibly is loaded less.

A kinematic adjusting mechanism here in particular is understood to be an adjusting mechanism with a plurality of (at least two) adjustable components, via which an adjusting force generated by the motor-type adjusting drive can be transmitted to the interior assembly for its adjustment.

An adjustment event, which can be detected by means of the electronic detection device, is understood to be any driver or operating situation induced by the adjusting drive, in which an external force acts on the drive device and/or the interior assembly, which in principle can lead to its adjustment. Here, it is not absolutely necessary that the electronic detection device detects the application of an external force on the drive device and/or the interior assembly itself. It can rather be sufficient that a corresponding situation for example is detected by a change in an adjustment position of at least one monitored component, which does not form part of the drive device or the interior assembly, and/or a corresponding situation is signaled by a signal to be received and processed at the detection device, which indicates that external forces which go beyond a tolerated extent (in particular) act on the drive device and/or the interior assembly. The electronic detection device for example can detect or be signaled that parts of the interior vibrate in the vehicle and/or the vehicle travels on a rough road. Alternatively or additionally, the detection device for detecting an adjustment event can detect an adjustment of a component of the drive device or the interior assembly, for example an adjustment of a component of an adjusting motor of the adjusting drive, and here in particular of a rotor, in order to infer the occurrence of an adjustment event. What is included here in particular is the possibility to electronically detect an adjustment event already before an unwanted movement or adjustment of a component of the interior assembly. By means of a gyrosensor, for example, a relevant acceleration can be detected at the interior assembly or the vehicle already before an actual unwanted movement.

In mechanics, self-locking is understood to be a friction-induced resistance against the slipping or rotation of two bodies resting against each other. In a transmission, self-locking exists when the transmission can be driven via the drive shaft, but not via an output shaft. Self-locking in transmissions can also be characterized by a high gear ratio or by a small efficiency (usually <50%). In a worm gear or a spindle gear self-locking usually is achieved when a pitch angle of a worm thread or a spindle thread is smaller than the arc tangent of the coefficient of static friction.

The kinematic adjusting mechanism preferably is not self-locking. When moved, a torque on the output side thus in principle can cause a movement of the kinematic adjusting mechanism.

In one design variant, the control device is configured to cause a reset of at least one component of the adjusting drive and/or at least one component of the kinematic adjusting mechanism into a target position in response to the detection of the adjustment event via the motor-type adjusting drive and the opposing force generated therewith, and to keep the at least one component at the target position with the external force still applied via the generated opposing force. A target position to be taken can be defined in particular by a position within a target range. Consequently, when the component to be adjusted is located within the target range, the taking of a target position is assumed. In particular, a possible reset of the at least one component of the adjusting drive and/or of the at least one component of the kinematic adjusting mechanism can depend on whether an adjustment of this component can be detected by means of the electronic detection device in order to detect the occurrence of an adjustment event. For example, especially with reference to a possible undesired adjustment of a particular component of the adjusting drive, which is not induced by the actuation of the adjusting drive, it can be detectable that due to an applied external force an adjustment of the component and hence possibly of the interior assembly is effected or—in the case of a further adjustment of the monitored component—would be effected. The control device then actuates the motor-type adjusting drive in order to adjust the component back into the target position or into a target range and keep it at this target position. When the specified target position or a position within a target range is reached again, this can be detected for example sensorily by means of the detection device and hence can be checked.

The detection as to whether the target position has been reached in principle can also consider a hysteresis or a tolerance window. In the present case, this for example means to overcompensate an adjusting movement made already, detected and resulting from the adjustment event, so that a corresponding adjustment subsequently becomes less probable or can be effected more rarely. For example, it can be provided that starting at a particular deviation from a target position the respective component is adjusted by a defined measure (defined by the tolerance window) in the opposite direction beyond the target position as a result of the generated opposing force.

The target position for example can have been stored by means of the control device in a memory of the control device, after an adjustment of the interior assembly has been completed by action of an adjusting force generated by the adjusting drive. After termination of a user-controlled or automatically triggered targeted adjustment of the interior assembly, a position taken by at least one component of the drive device thus can be stored in order to assess a subsequent possible displacement of this component without actuation of the adjusting drive as a possible occurrence of an adjustment event, which must lead to the generation of an opposing force. Thus, when a user-controlled or automatically triggered adjustment of the interior assembly has been terminated up to a specified target position, a target position of a component of the drive device monitored for example sensorily is stored in order to counteract by means of the adjusting drive in the case of a detected undesired adjustment from this target position due to the action of an external force. Storing a target position here can include the fact that the position taken after a targeted adjustment is set as the target position. The detection device thus merely checks with reference to subsequently possibly generated detection signals (possibly by taking account of an adjustment direction) whether a change in position occurs without the adjusting drive being actuated. This in particular includes the fact that detection signals are generated by at least one or exactly one Hall sensor or rotor position sensor, by means of which signal changes per revolution or angular degrees within a revolution can be measured and a change in position can be inferred by counting the rotations, e.g. by means of a controller coupled with the sensor.

In principle, the applied opposing force can be varied in its height over time by means of the control device. For example, this can also take account of a changed external force.

The proposed solution in particular, as already explained above, is suitable for adjusting drives without a self-locking feature and kinematic adjusting mechanisms without a self-locking feature. Correspondingly, one design variant also provides that the adjusting drive comprises a non-self-locking transmission. With external forces, the kinematic adjusting mechanism thus cannot be kept in a particular adjustment position via a self-locking feature of the transmission on the side of the adjusting drive. The generation of the opposing force by means of the motor-type adjusting drive then is provided for this purpose. By avoiding a non-self-locking transmission as part of the adjusting drive the adjusting drive regularly can be designed lighter in weight and more compact. Moreover, a faster response behavior thereby can be achieved when actually an adjustment of the interior assembly is desired.

In a possible design variant, a short-circuit brake is provided for generating the opposing force or for increasing the opposing force. An adjusting motor of the adjusting drive then can generate a braking effect, in particular permanently, in the case of an emerging adjustment of a monitored component or in the case of an applied on-board signal received at the detection device, such as for example a crash warning.

As already explained here, the detection device in principle can be provided for monitoring at least one component of the adjusting drive and/or for monitoring at least one component of the kinematic adjusting mechanism. In principle, monitoring of the interior assembly itself of course is possible alternatively or additionally in order to infer the presence of a possible adjustment event. When an adjustment of the interior assembly or a part thereof is assumed to be relevant for the question of whether an adjustment event does exist, this however regularly is not desirable from a comfort point of view. It rather is perceived as advantageous that an undesired adjustment due to external forces is counteracted already within the adjusting drive and/or the kinematic adjusting mechanism, before an adjustment of the interior assembly perceptible or visible for a user is effected.

For monitoring purposes, the detection device can comprise a monitoring sensor system with at least one sensor. For example, optical, magnetic or capacitive sensors are conceivable therefor, in particular sensors by means of which a changed adjustment position can be detected. For example, in particular at least one Hall sensor or an analog, magnetic rotor position sensor is provided. Alternatively or additionally, a radar or lidar sensor and/or a camera can be used.

One design variant alternatively or additionally provides sensorless monitoring of at least one component of the adjusting drive and/or the kinematic adjusting mechanism. For example, sensorless monitoring of a component of an adjusting motor of the adjusting drive can be effected on the basis of measurable and electronically evaluable motor parameters, such as for example induction voltage or motor impedance. For example, sensorless monitoring can be provided via the evaluation of electrical signals representative of corresponding motor parameters on a DC motor of the motor-type adjusting drive.

In one design variant the detection device is provided to monitor an adjustment position of a rotor of the adjusting motor in order to infer a possible adjustment event which triggers the generation of the opposing force. As explained, such monitoring can be effected sensorily, for example by means of a monitoring sensor system of the detection device, or in a sensorless way.

When a monitoring sensor system is provided, the same can be arranged and configured to detect the occurrence of an adjustment event via an adjustment of a component of an adjusting motor of the adjusting drive and hence in particular of a rotor of the adjusting motor, which is caused by the external force. This for example includes the fact that the monitoring sensor system for monitoring a rotor of the adjusting motor comprises at least one Hall sensor. A dual Hall sensor or a plurality of Hall sensors can also be provided to detect a direction of rotation of the rotor and thereby infer the presence of an adjustment of the rotor not induced by the adjusting drive and hence infer an adjustment event. When using only exactly one Hall sensor on a rotor of the adjusting motor, additional information on the direction of rotation and/or direction of action of gravity, possibly can also be evaluable by the detection device, for example via an on-board electronic unit, in order to infer the presence of an adjustment event. For example, the direction of action of gravity on a component is important when an adjustment with a height component is to be effected via the adjusting drive.

The monitoring sensor system in principle can completely or at least partly be placed on a circuit board of the motor-type adjusting drive. In particular, the monitoring sensor system can be integrated on the adjusting motor and be connected to a circuit board of the adjusting drive including the electronic control system by means of at least one signal line.

An adjusting motor of the adjusting drive for example can be a DC motor, in particular a brushless DC motor (briefly BLDC motor).

For sensorless monitoring of a DC motor, e.g. monitoring of an adjustment position of a rotor of the DC motor, a detection device can be provided for example, which utilizes an inductive voltage divider or a measurement voltage pulse. When utilizing an inductive voltage divider, pulses or an alternating voltage then for example are applied to two motor phases and a voltage measurement is carried out on a third motor phase. A position of the rotor thus influences the individual inductances and hence a measurable tapping voltage. When a measurement voltage pulse is utilized, the motor phases can be charged therewith. Rises of the (phase) currents in the time domain then suggest a (changed) adjustment position of the rotor.

In an alternative design variant, a motor impedance is measured for sensorless monitoring of an adjustment position of the rotor by means of the detection device. A rotation on a commutator of the DC motor at standstill can be determined thereby, in order to infer an adjustment position of the rotor possibly changed by external forces and hence infer the presence of an adjustment event.

In one design variant, the detection device is configured to detect an adjustment event by an on-board sensor signal. For this purpose, for example at least one sensor present already on the vehicle is utilized, whose sensor signal can be transmitted to the detection device. Via the on-board sensor signal, for example a ride on a rough road detected on the vehicle, an offroad ride or a vibration on the vehicle body and/or in the vehicle interior exceeding a tolerance threshold can then be signaled. In such a case, a trigger criterion for activation of a counteracting mode of the control device is regarded as fulfilled, so that in response thereto an opposing force is generated in order to again take and maintain a current (target) position of components of the kinematic adjusting mechanism and possibly in particular of the motor-type adjusting drive.

In one design variant, the detection device is configured to detect a change in an adjustment position of at least one component of the adjusting drive and/or at least one component of the kinematic adjusting mechanism in dependence on an operating mode of the drive device and in response thereto newly initialize a reference position for the at least one component, which is relevant for the detection of an adjustment event. Then, for example, the detection device can detect a completed, but (initially) undetected and unwanted change in an adjustment position, e.g. a rotation, in a monitoring sensor system taking account of relative positions and trigger a new initialization of a reference position (for a target position desired on the part of a user), e.g. after a deep-sleep, a transport mode or draining of a battery supplying the electronic unit of the drive device with energy.

In one design variant, the detection device can be configured to (only) be put into a detection mode by an activation signal generated on-board of the vehicle and received at the detection device or by an activation signal generated by a sensor of the detection device, in that an adjustment event can be detected by the detection device. Thus, the detection device can be operable for example in a sleep mode, from which the detection device changes into a detection mode only in response to an activation signal. From this detection mode a change into a counteracting mode in turn is possible, in order to actuate the adjusting drive for generating the opposing force, when an adjustment event subsequently is detected. A possible operation in a sleep mode offers quite considerable energy saving potentials. Thus, a detection device only is put into a detection mode requiring more energy when due to the current driving situation of the vehicle or an electronically (sensorily or in a sensorless way) detected changed adjustment position of a component of the drive device and/or the interior assembly it turns out that possibly disturbing external forces exceeding a tolerable threshold will act on the interior assembly, which might lead to an undesired adjustment of the interior assembly. This can also include the fact that for example a ride on a rough road detected on the vehicle, an offroad ride or a vibration on the vehicle body and/or in the vehicle interior exceeding a tolerance threshold leads to the generation of an activation signal.

In response to an activation signal a complete electronic unit of the drive device or at least of the adjusting drive, including the control device, possibly also can be switchable first from a current-saving sleep mode into an adjusting mode.

Alternatively or additionally it can be provided that in a sleep mode the detection device at predefined times and hence in particular cyclically carries out a check for the presence of an activation event, which leads to the change into the detection mode, or for the presence of an adjustment event which already triggers the generation of the opposing force. For example, the detection device present in the sleep mode can wake up cyclically and carry out a check for a possible change in an adjustment position of a component, such as a rotor, caused by an external force, in order to detect an adjustment event. Thus, the detection device can be configured to carry out a-comparatively current-saving-polling with which the change of an adjustment position of a component of the adjusting drive and/or a component of the kinematic adjusting mechanism is monitored.

For generating an activation signal, an accelerometer of the detection device and/or a Hall sensor and/or an analog, magnetic rotor position sensor can be provided in one design variant. Then, for example, an activation of the control device (e.g. implemented in a controller of the drive device) can only be effected by at least one activation signal which is generated by an accelerometer. Such an accelerometer can be integrated for example as a component on an electronic unit of the adjusting drive, in particular in a microcontroller of the control device. Alternatively or additionally, Hall signals or analog signals can be utilized (directly or with a comparator or the like) as a wakeup source for the control device.

Part of the proposed solution furthermore is a vehicle seat with a design variant of a proposed drive device. In one design variant of such a vehicle seat a seat height adjustment without a self-locking feature, in particular by utilizing a BLDC motor as part of the adjusting drive, for example is provided with the drive device. By means of a control device, in particular integrated into a controller of the seat height adjustment, an opposing force can specifically be generated here via the adjusting drive in response to a possibly detected adjustment event, which counteracts an undesired change in seat height, unless the adjusting drive is specifically actuated for this purpose.

Different applications for a drive device of the described type are conceivable and possible. In one application, the interior assembly can be realized for example by a vehicle seat. The drive device here can be configured in particular for adjusting a backrest of the vehicle seat relative to a seat part of the vehicle seat. Alternatively, the drive device can be configured for a longitudinal seat adjustment. In turn alternatively, the drive device can be configured for a seat height adjustment.

In another application, the interior assembly can be realized for example by a console element, for example a center console, an armrest, a table or another assembly in the vehicle interior.

### BRIEF DESCRIPTION OF THE FIGURES

The attached Figures by way of example illustrate possible design variants of the proposed solution.

FIG. 1 shows a schematic view of a vehicle with various interior assemblies and a design variant of a proposed drive device.

FIG. 2 schematically shows components of a proposed drive device for the adjustment of an interior assembly of the vehicle of FIG. 1.

FIG. 3 shows a control device of the drive device corresponding to FIG. 2 by representing additional components.

FIG. 4 shows a possible sequence for operating the drive device.

### DETAILED DESCRIPTION

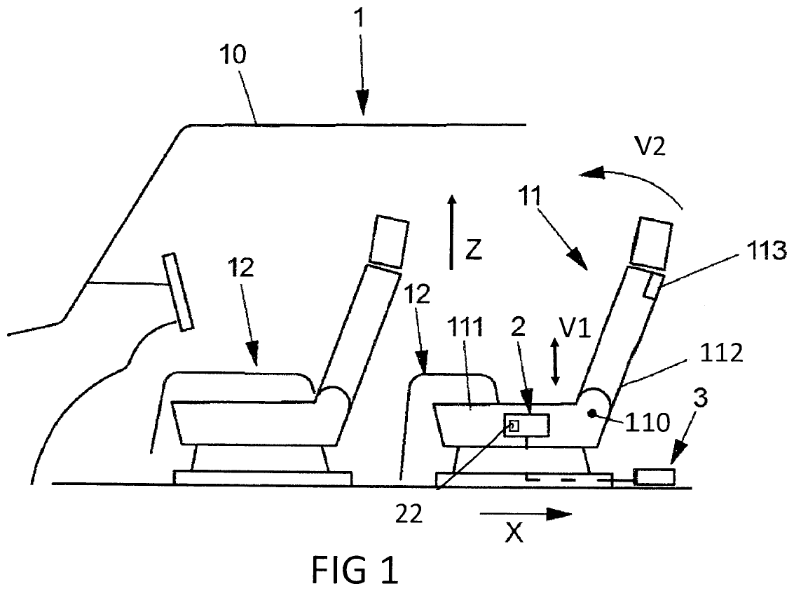

FIG. 1 in a schematic view shows a vehicle 1 which forms an interior space enclosed by a vehicle body 10, in which different interior assemblies for example in the form of vehicle seats 11 and console elements 12 and also possibly further interior assemblies such as monitors, dividing walls, shelves, storage compartments or the like are arranged.

In the context of novel interior concepts, for example in connection with autonomously driving vehicles, interior assemblies 11, 12 can be variably adjustable in the interior of a vehicle 1.

For example, an interior assembly 11 in the form of a vehicle seat can be variably adjustable in order to adjust the vehicle seat along an adjusting plane defined by the vehicle longitudinal direction X and a vehicle transverse direction and also possibly rotate the same about a vertical vehicle axis Z. Assemblies of the vehicle seat, for example a seat part 111 or a backrest part 112, also can be adjustable in order to adapt the position of the respective assembly. For example, the backrest part 112 can be adjustable in its inclination. Moreover, the seat part 111 can be adjustable in its height position along an adjustment direction V1 and also in its tilt position.

For adjusting an interior assembly 11, 12, as this is schematically shown in FIG. 1, there is provided a drive device with a motor-type adjusting drive 2 which is connected with a control device 3 of the drive device. The adjusting drive 2 is of electromotive design and can be operated to electromotively move an associated interior assembly 11, 12 between different positions.

In principle, a separate electromotive adjusting drive 2 can be associated to each interior assembly 11, 12 to be adjusted or to a sub-assembly of an interior assembly 11, 12 to be adjusted, for example to the backrest part 112 of a vehicle seat, wherein the adjusting drives 2 for example can be connected to a common control device 3 so that the control device 3 jointly controls the adjusting drives 2 for adjusting the associated interior assembly 11, 12.

By using the drive device, an associated interior assembly 11, 12 can be adjustable along a defined path of movement. For example, a vehicle seat can be longitudinally shiftable relative to the vehicle floor along the vehicle longitudinal direction X along a path of movement defined by guide rails. A backrest part 112 also can be pivotable relative to the seat part 111 about a defined pivot axis 110, for example along an adjustment direction V2, onto the seat part 111.

It is also conceivable, however, that an interior assembly 11, 12 is freely movable along a vehicle floor of the vehicle 1 and thus can be freely adjusted in the interior space and for example can be arrested at defined anchor points in the interior space. In so far, for example guide rails for defining a fixed, specified path of movement need not necessarily be provided.

The control device 3, which for example is integrated into a controller, is coupled with a detection device 22. In FIG. 1, this detection device 22 by way of example is integrated into the adjusting drive 2, which however is not absolutely necessary. The electronic detection device 22 is adapted and provided for detection of an adjustment event, in which at least one external force acts on the adjusting drive 2. Under the action of the external force there is the risk that at least one component of the adjusting drive 2 and/or a kinematic adjusting mechanism coupled with the adjusting drive 2 is displaced for adjusting an assembly of an interior assembly 11, 12—here for example of the vehicle seat 12—, without the adjusting drive 2 being actuated. By means of the detection device 22 it can then for example electronically (sensorily or in a sensorless way) be detectable whether the motor vehicle 1 is traveling on a rough road and hence there is a risk that an assembly of the interior assembly 11, 12 is displaced undesirably. Via the control device 3 an opposing force then is generated by means of the adjusting drive 2, which counteracts an undesired displacement or adjustment caused thereby. Such an electronic counteraction by means of the adjusting drive 2 in particular is advantageous when the adjusting drive 2 is designed without a self-locking feature and hence for example with a non-self-locking transmission, and a DC motor, in particular a BLDC motor is utilized as an adjusting motor for the adjusting drive 2.

The detection device 22 for example integrates a monitoring sensor system with one or more Hall sensors in order to monitor an adjustment position of a component of the adjusting drive, e.g. an adjustment position of a rotor of the adjusting motor. When then a displacement of the rotor beyond a measure regarded as reliable, and here especially in a particular direction of rotation, for example is detected sensorily without actuation of the adjusting motor, the presence of an adjustment event is inferred and the control device 3 is caused to counteract. The control device 3 then actuates the adjusting motor in order to set the rotor back into a previously taken target position or into a target range and to keep the rotor at the target position or in a predefined target range.

The detection device 22 can also be configured and provided for sensorless monitoring. For example, in a BLDC motor of the adjusting drive 2 an inductive voltage divider can be utilized in order to infer a possibly changed rotor position with reference to a tapping voltage. Alternatively, a measurement voltage pulse can be utilized in order to evaluate current rises in the time domain and on this basis infer a possibly changed rotor position. When a differently designed DC motor is provided, the motor impedance for example can be measured by means of the detection device 22. A rotation at the commutator of the DC motor at standstill leads to a changed motor impedance and hence can be regarded as an indication that an undesired change in the rotor position has occurred.

For an alternatively or additionally provided sensory detection of an adjustment position of the backrest part 112 the same can integrate a backrest sensor 113. A backrest sensor 113 provided at the backrest part 112 then likewise represents a detection device in the sense of the proposed solution, by means of which an adjustment event can be inferred for counteracting by means of the control device 3. When a vibration of the backrest part 112 for example is sensed via the backrest sensor 113, the control device 3 can actuate the adjusting drive 2 to counteract, which acts via a kinematic adjusting mechanism and here in particular on a fitting rotatably coupling the backrest part 112 with the seat part 111, in order to keep the backrest part 113 in the position taken relative to the seat part 111.

The design variant of a proposed drive device shown with FIG. 1 by way of example thus permits an electronic position control in order to for example absorb particular loads occurring at the adjusting drive 2 and the downstream kinematic adjusting mechanism (i.e. loads which go beyond the measure of a usual adjustment) and counteract the same in an electronically controlled way. This can provide for an easier integration of a transmission without a self-locking feature into the adjusting drive 2 and/or the kinematic adjusting mechanism coupled therewith. A corresponding design without a self-locking feature typically involves less installation space, less weight and less wear.

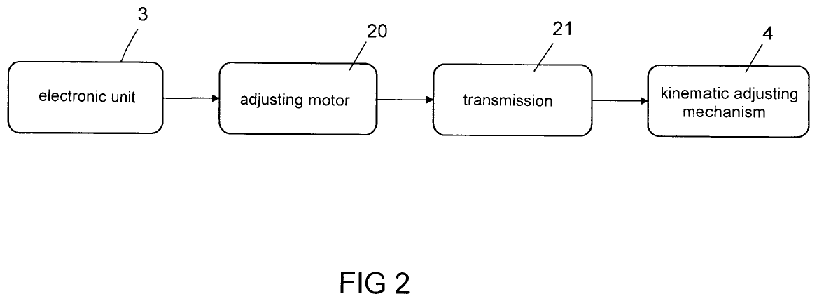

FIG. 2 by way of example shows the cooperation of different components of a proposed drive device. With its electronic unit, the control device 3 acts on an adjusting motor 20 of the adjusting drive 2. The adjusting motor 20 in turn is coupled with a transmission 21—here a non-self-locking transmission and hence without a self-locking feature—, which in turn acts on a kinematic adjusting mechanism 4. Such a kinematic adjusting mechanism 4 for example includes at least two components of an adjusting mechanism coupled with each other, via which an adjusting force generated by the adjusting motor 20 and transmitted via the transmission 21 is used for adjusting an interior assembly 11, 12.

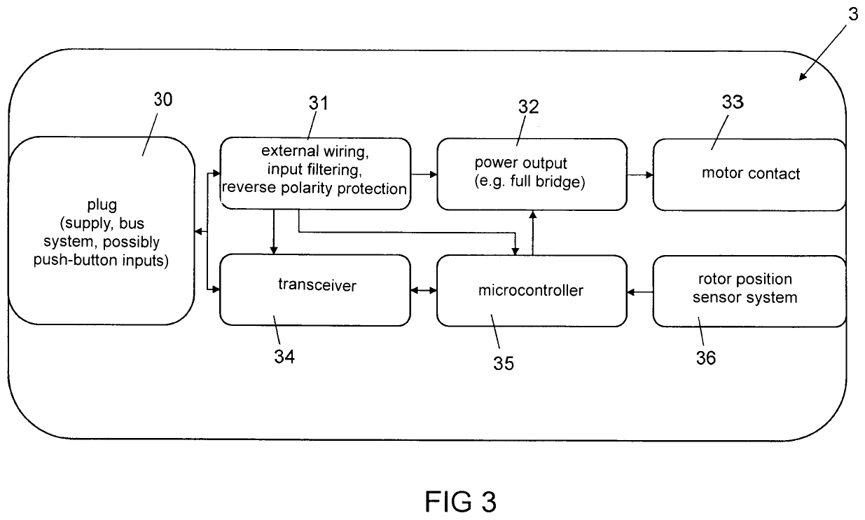

FIG. 3 illustrates a variant of the control device 3 and in particular parts of the electronic unit integrated therein. The illustrated control device 3 also integrates parts of the detection device 22, here in the form of a rotor position sensor system 32, by means of which the position of a rotor of the adjusting motor 20 of the adjusting drive 2 is monitored. In addition, the control device 3 of FIG. 3 comprises a plug 30 via which a supply of the control device 3 with electricity and/or the connection to a bus system of the vehicle 1 is effected. Possibly, push-button inputs also are provided via the plug. Furthermore, in FIG. 3 by way of example an external circuitry 31, a power output 32 and a motor contact (for the adjusting motor 20) as well as a transceiver 34 and a microcontroller 35 form part of the control device 3. The microcontroller 35 integrates an evaluation logic for the detection of an adjustment event. For this purpose, the microcontroller 35 evaluates measurement signals of the rotor position sensor system 35, for example signals of one or more Hall sensors or an analog, magnetic rotor position sensor, via which a changed position of a rotor of the adjusting motor 2 can be detected.

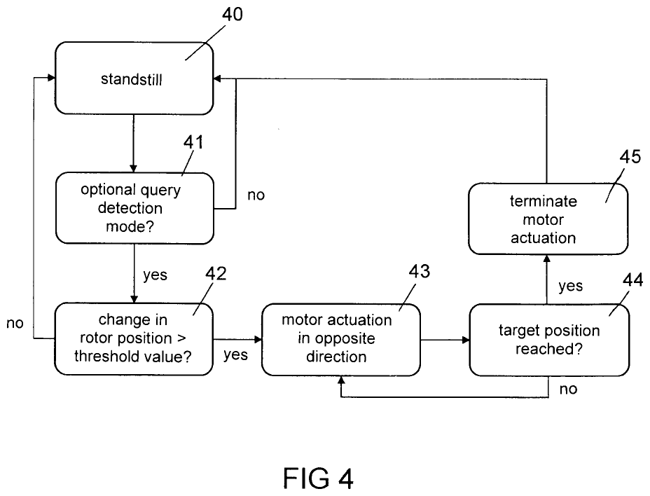

FIG. 4 shows a flow diagram for an exemplary method to be realized with a design variant of a proposed drive device. After a possible standstill 40 after a motorized adjustment of an interior assembly 11, 12 carried out properly a target position taken is monitored. Consequently, corresponding to a step 42 of FIG. 4 it is monitored whether a rotor position of a rotor of the adjusting motor 20 is changed beyond a stored threshold value and hence the rotor of the adjusting motor 20 possibly rotates undesirably due to forces applied from outside without actuation of the adjusting drive 2. Before a corresponding monitoring an optional query 41 can be provided, as to whether a corresponding detection mode has been activated for monitoring the rotor position.

When no change is detected during the monitoring of the rotor position, the adjusting drive 2 (without a self-locking feature) remains at standstill. When on the other hand a change in the rotor position beyond a stored threshold value (for example a specified number of Hall pulses) is detected, the control device 3 actuates the adjusting motor 20 corresponding to step 43 of FIG. 4 to perform a rotation of the rotor back into an originally taken target position. In particular, the adjusting motor 20 is actuated to perform an adjustment of the rotor in an opposite direction, i.e. against a previously detected direction of rotation, due to externally caused forces, until the target position is reached. The reaching of the target position also can include the fact that merely an adjustment of the rotor into a target range is detected-for example by detection of a certain number of Hall pulses in the opposite direction. When the reaching of a corresponding target position has been detected electronically corresponding to step 44 of FIG. 4, the motor actuation is terminated by the control device 3 in a succeeding step 45.

Instead of a monitoring by means of sensors or a sensorless evaluation of measured motor parameters as explained above, e.g. by means of an inductive voltage divider, measurement voltage pulse or a measurement of the motor impedance, a detection of an adjustment event by one or more accelerometers can also be provided in principle, which accelerometers are not necessarily provided at the rotor of the adjusting motor 20. For example, an accelerometer can also be integrated as a component in the control device 3 and in particular the microcontroller 35.

Furthermore, for actuating the adjusting motor 20 the control device 3 can take account of additional control information or vehicle information, such as a vehicle inclination and/or measurement signals of on-board (additional) sensors, in particular optical or capacitive sensors, in particular radar or lidar sensors and/or cameras, in particular sensors which are provided for monitoring the interior space.

The idea underlying the solution moreover is not limited to the exemplary embodiments described above, but can also be realized in a different way.

The interior assembly can be realized by entirely different assemblies in the interior of a vehicle and in so far is not limited to a vehicle seat or a console element. An interior assembly for example can also be a monitor, a shelf (for example in the form of a table or the like), a dividing wall, a storage compartment or the like.

### LIST OF REFERENCE NUMERALS

1 motor vehicle
10 vehicle body
11 vehicle seat (interior assembly)
110 pivot axis
111 seat part
112 backrest part
113 backrest sensor (detection device)
12 console element (interior assembly)
2 adjusting drive
20 (adjusting) motor
21 transmission
22 detection device
3 control device
30-36 control component
4 kinematic adjusting mechanism
V1, V2 adjustment direction
X longitudinal vehicle axis
Z vertical vehicle axis

1. A drive device for adjusting an interior assembly of a vehicle, at least comprising
a motor-type adjusting drive for generating an adjusting force,
a kinematic adjusting mechanism to be driven by the adjusting drive for transmitting an adjusting force generated by the adjusting drive to the interior assembly,
a control device for controlling the adjusting drive, and
an electronic detection device for detecting an adjustment event, in which at least one external force acts on at least one of the drive device and the interior assembly,
wherein the control device is configured to generate an opposing force via the motor-type adjusting drive in response to the detection of the adjustment event, which counteracts an adjustment of the interior assembly due to the external force.

2. The drive device according to claim 1, wherein the control device is configured to cause a reset of at least one of at least one component of the adjusting drive and at least one component of the kinematic adjusting mechanism into a target position in response to the detection of the adjustment event via the motor-type adjusting drive and the opposing force generated therewith, and to keep the at least one component at the target position with the external force still applied via the generated opposing force.

3. The drive device according to claim 2, wherein the target position is specified as a position within a target range.

4. The drive device according to claim 2, wherein the control device comprises a memory and is configured to store the target position after an adjustment of the interior assembly has been completed under the action of an adjusting force generated by the adjusting drive.

5. The drive device according to claim 1, wherein the adjusting drive comprises a non-self-locking transmission.

6. The drive device according to claim 1, wherein for generating the opposing force or for increasing the opposing force the adjusting drive can be operated as a short-circuit brake.

7. The drive device according to claim 1, wherein the detection device is provided for monitoring at least one of at least one component of the adjusting drive and the kinematic adjusting mechanism.

8. The drive device according to claim 7, wherein the detection device is provided to monitor an adjustment position of a rotor of the adjusting motor.

9. The drive device according to claim 7, wherein the detection device comprises a monitoring sensor system which is provided to detect the occurrence of an adjustment event via an adjustment of a component of the adjusting motor of the adjusting drive caused by the external force.

10. The drive device according to claim 9, wherein the monitoring sensor system for monitoring the rotor comprises at least one Hall sensor or at least one analog, magnetic rotor position sensor.

11. The drive device according to claim 1, wherein an adjusting motor of the adjusting drive is a DC motor, in particular a brushless DC motor.

12. The drive device according to claim 8, wherein an adjusting motor of the adjusting drive is a brushless DC motor, wherein the detection device is provided to utilize an inductive voltage divider or a measurement voltage pulse for monitoring an adjustment position of the rotor of the brushless DC motor.

13. The drive device according to claim 8, wherein an adjusting motor of the adjusting drive is a DC motor, wherein the detection device is provided to measure a motor impedance for monitoring an adjustment position of the rotor of the DC motor.

14. The drive device according to claim 1, wherein the detection device is configured to detect an adjustment event by an on-board sensor signal.

15. The drive device according to claim 1, wherein the detection device is configured to cyclically carry out a check for a possible change in an adjustment position of at least one of at least one component of the adjusting drive and at least one component of the kinematic adjusting mechanism in order to detect an adjustment event.

16. The drive device according to claim 1, wherein the detection device is configured to detect a change in an adjustment position of at least one of at least one component of the adjusting drive and at least one component of the kinematic adjusting mechanism in dependence on an operating mode of the drive device and in response thereto newly initialize a reference position for the at least one component, which is relevant for the detection of an adjustment event.

17. The drive device according to claim 1, wherein at least one of
the detection device is configured to be put into a detection mode by an activation signal generated on-board of the vehicle and received at the detection device or by an activation signal generated by a sensor of the detection device, in that an adjustment event can be detected by the detection device, and
the control device is configured to be put from a sleep mode into an adjusting mode by an activation signal generated on-board of the vehicle and received at the control device or by an activation signal generated by a sensor of the detection device, in that a control of the adjusting drive is effected.

18. The drive device according to claim 17, wherein for generating the activation signal at least one of an accelerometer of the detection device and/or, a Hall sensor and an analog, magnetic rotor position sensor is provided.

19. A vehicle seat comprising a drive device according to claim 1.

20. The drive device according to claim 11, wherein the DC motor is a brushless DC motor.
